(19) United States
(12) Patent Application Publication
(10) Pub. No.: US 2003/0198302 A1
(43) Pub. Date: Oct. 23, 2003

(54) DC-tolerant bit slicer and method

(75) Inventor: Bang-Sup Song, LaJolla, CA (US)

Correspondence Address: KOPPEL, JACOB, PATRICK & HEYBL, Suite 107, 555 St. Charles Drive, Thousand Oaks, CA, 91360, US

(73) Assignee: WIRELESS INTERFACE TECHNOLOGIES, INC.

(21) Appl. No.: 10/125,030

(22) Filed: Apr. 17, 2002

(51) Int. Cl. H04L 27/06

(52) U.S. Cl. 375/340

(57) ABSTRACT

A bit slicer circuit and method detect the peak of the differential slope in a demodulated data signal received via a wireless data system, so that bit slicing can be insensitive to DC fluctuations. This is accomplished by detecting when the demodulated signal transitions by more than a predetermined threshold value Vₜₕ during each symbol period, and determining the polarity of a detected transition. A latch is set and a logic “1”, is output when the polarity of a detected transition is negative; the latch is reset and a logic “0” is output when the polarity is positive.

### BACKGROUND OF THE INVENTION

1. Field of the Invention

This invention relates to the field of wireless data systems, and particularly to techniques for extracting digital data from a received and demodulated wireless signal.

2. Description of the Related Art

Many wireless data systems, such as that defined in the “Bluetooth” standard, convey digital data on a frequency-modulated carrier. When a received signal is demodulated, it can contain a large DC offset which varies over time. This DC component results from two sources: the DC offset of the receiver itself, and the DC offset which arises due to the difference between the transmitter and receiver carrier frequencies. The amount of DC offset due to the latter source is directly proportional to the carrier frequency mismatch. The receiver offset is essentially constant and can be easily corrected. But the DC offset due to carrier frequency mismatch appears only after the difference in carrier frequencies is demodulated. Low cost wireless systems such as Bluetooth are implemented using direct conversion or low-IF architectures, which require slow time-constant filtering or DC correction that results in a slowly varying DC offset. This varying offset makes it difficult to separate digital data from the demodulated output.

This problem is particularly acute for systems implementing the Bluetooth standard. Bluetooth transceivers hop to a new frequency slot before any data transmission and reception begins, and uses only the first four symbols as preamble—with each symbol having a period of 1 μs. This requires prompt data recovery within 4 μs at the onset of every new data packet. The problem of a varying DC offset is illustrated in FIG. 1 for a demodulated signal having a four symbol preamble.

A common solution to this problem is to use a “bit slicer”, which has a dynamic threshold that subtracts DC offset from the demodulated signal by some means. Two possible approaches are shown in FIGS. 2a and 2b. In FIG. 2a, a comparator 10 compares the demodulated input signal (In) with a time-averaged version of the input signal. However, this technique is ineffective for a system like Bluetooth, because it takes too long to average out the DC term from the data. In FIG. 2b, peak and bottom detectors (12, 14) are used to obtain the midpoint of the demodulated signal, which is provided to a comparator 16 along with the demodulated signal to extract the digital data. Peak and bottom detectors may be unreliable, however: peaks are stored on capacitors—if the discharging time is too slow, local peaks can be missed. However, if the discharging time is too fast, a peak may be lost before it is detected.

### SUMMARY OF THE INVENTION

A bit slicer circuit and method are presented which overcome the problems noted above, accurately extracting digital data from a demodulated signal despite the presence of a varying DC offset.

The present bit slicer detects the peak of the differential slope in a received and demodulated data signal, so that bit slicing is rendered insensitive to any DC fluctuation. This is accomplished by detecting when the demodulated signal transitions by more than a predetermined threshold value Vₜₕ during each symbol period, and determining the polarity of a detected transition. A latch is set (and a logic “1” is output) when the polarity of a detected transition is positive, and is reset (outputting a logic “0”) when the polarity is negative.

To detect a transition, a symbol delay line is used which implements a function of (1-D), where D is one symbol period and the output of the symbol delay line varies with the difference between the value of the demodulated signal and its value one symbol period earlier. After sensing the polarity of the transition, the peak or bottom of the differential slope is detected and used to trigger the setting and resetting of the latch.

Further features and advantages of the invention will be apparent to those skilled in the art from the following detailed description, taken together with the accompanying drawings.

### BRIEF DESCRIPTION OF THE DRAWINGS

FIG. 1 is a graph illustrating the problem of a varying DC offset in a demodulated signal found in prior art receivers.

FIGS. 2a and 2b are schematic diagrams of known techniques for correcting DC offset in a demodulated signal.

FIG. 3a is a block diagram of a DC-tolerant bit slicer in accordance with the present invention.

FIG. 3b is a timing diagram which illustrates the operation of the bit slicer shown in FIG. 3a.

FIG. 4 is a block diagram of a digital implementation of a symbol delay line as might be used with the present invention.

FIG. 5a is a block diagram of an analog implementation of a symbol delay line as might be used with the present invention.

FIG. 5b is a timing diagram which illustrates the operation of the symbol delay line shown in FIG. 5a.

FIGS. 6a and 6b are schematic diagrams of analog delay elements as might be used with the present invention.

FIG. 7a is a block diagram of a digital implementation of a slope polarity detector as might be used with the present invention.

FIG. 7b is a block diagram of an analog implementation of a slope polarity detector as might be used with the present invention.

FIG. 8 is a block diagram of an implementation of a slope level threshold detector as might be used with the present invention.

FIG. 9 is a schematic diagram of a capacitive threshold subtractor as might be used with the slope level threshold detector shown in FIG. 8.

FIG. 10 is a block diagram of an implementation of a slope polarity detector as might be used with the present invention.

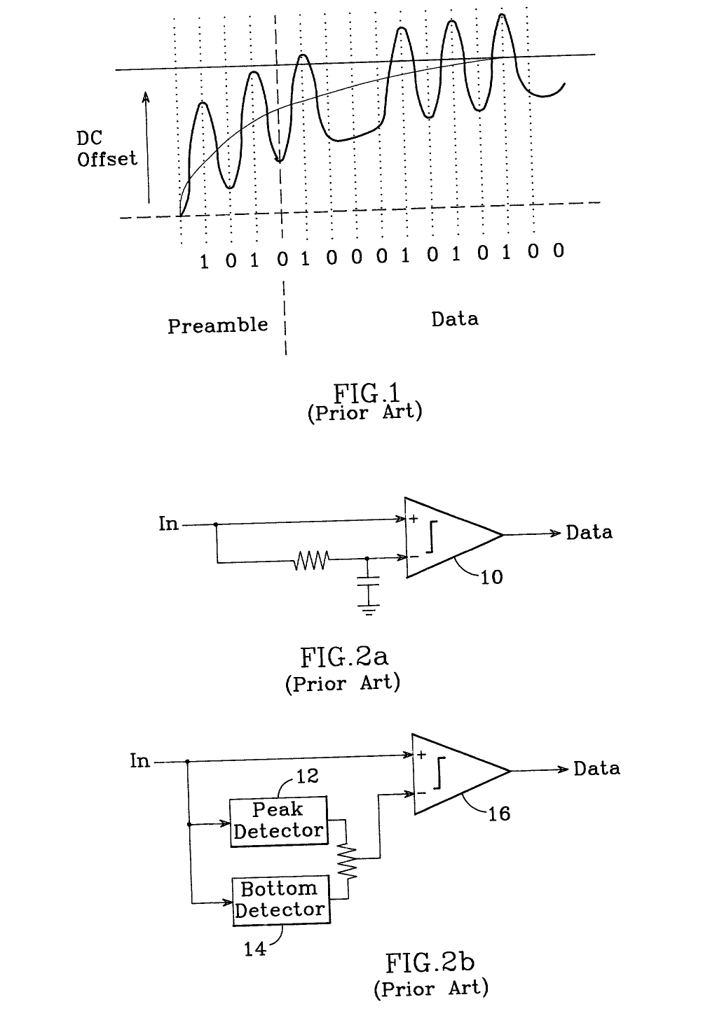

### DETAILED DESCRIPTION OF THE INVENTION

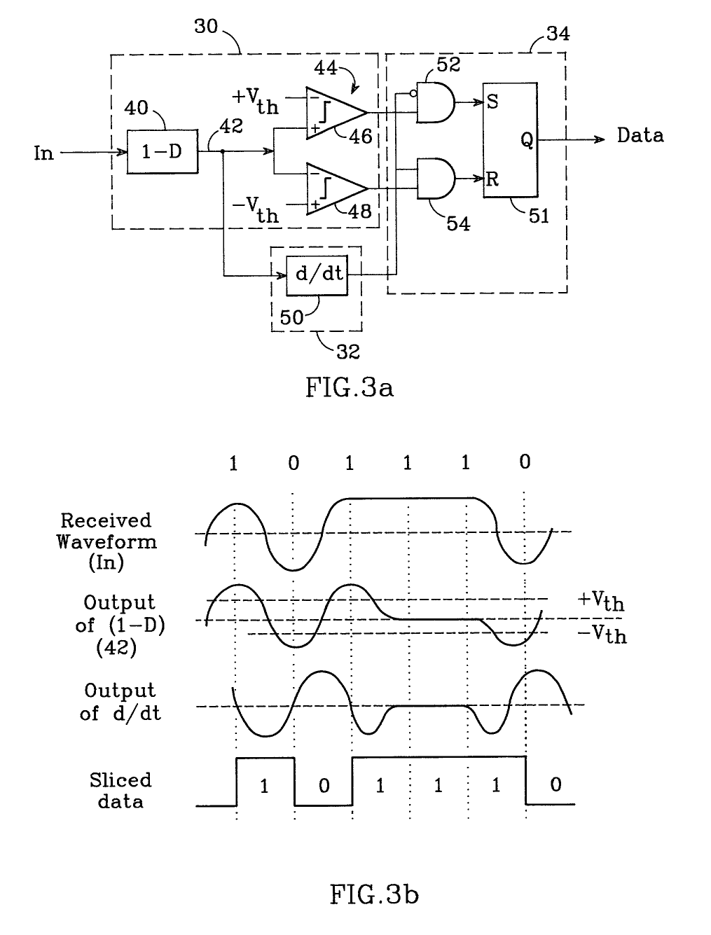

A DC-tolerant bit slicer in accordance with the present invention is shown in FIG. 3a. The invention is suitably employed in a wireless data system in which digital data is conveyed using frequency-modulation (FM). The wireless data system has a characteristic “symbol period”, which is referred to herein as “D”; a predetermined number of symbols form a “preamble” which precedes every data packet conveyed by the system. For example, in the Bluetooth standard, the preamble comprises 4 symbols, and symbol period D is 1 μs. A signal received by the wireless data system is demodulated and provided to the present bit slicer, which separates the digital data from the DC components contained in the demodulated signal.

The bit slicer comprises a slope level threshold detector 30, a slope polarity detector 32, and a latch circuit 34. Slope level threshold detector 30 receives a demodulated input signal (In) from a wireless data system, and latch circuit 34 provides bit-sliced digital data at its output. The bit slicer is arranged to detect the peak of the differential slope in the received demodulated signal, so that bit slicing is made insensitive to any DC offset variation. The “differential slope” is defined as the signal change during one symbol period D.

As shown in FIG. 3a, slope level threshold detector 30 includes a symbol delay line 40 which implements a function of (1-D), such that the symbol delay line's output 42 varies with the difference between the value of the demodulated signal and the value of the demodulated signal one symbol period earlier. When the demodulated input signal makes a transition, the output of the symbol delay line provides the differential slope.

To determine whether the transition represents a logic state change in the incoming data, the magnitude of the differential slope is compared with a predetermined threshold value. This function is illustrated in FIG. 3a with a window comparator 44, which includes a first comparator 46 that receives output 42 and a positive threshold voltage +Vₜₕ, and a second comparator 48 which receives output 42 and a negative threshold voltage −Vₜₕ. The output of first comparator 46 toggles when the output of symbol delay line 40 exceeds +Vₜₕ, indicating that a positive transition of sufficient magnitude has occurred. Similarly, the output of second comparator 48 toggles when the output of symbol delay line 40 exceeds −Vₜₕ, indicating that a negative transition of sufficient magnitude has occurred.

Slope polarity detector 32 preferably comprises a differentiator 50. By differentiating the output of symbol delay line 40, the direction of the transition is determined: a negative-going transition results in a negative dip in the output of differentiator 50, while a positive-going transition results in a positive bump in the differentiator output. The differentiator output is used to determine the polarity of a transition in the demodulated input signal.

Latch circuit 34 includes a latch 51 which is arranged to be “set”, and thus output a logic “1”, when slope level threshold detector 30 detects a transition which exceeds +Vₜₕ and the polarity of the transition is determined to be negative; the polarity is determined to be negative immediately following the peak point of the transition, when the transition polarity reverses from positive to negative. This requirement that both level and polarity conditions be met to set latch 34 is accommodated using a gate 52, which AND's the output from comparator 46 with the inverted output of differentiator 50 to produce the “set” input delivered to latch 51. Latch circuit 34 is reset, and thus outputs a logic “0”, when the slope level threshold detector detects a transition which exceeds −Vₜₕ and has a positive polarity (i.e., when the transition polarity reverses from negative to positive); a gate 54 detects when these two conditions are met and provides the “reset” input to latch 51 accordingly. Latch 51 is preferably a “set-reset” (S-R) latch.

A comparator (not shown) may be interposed between the output of differentiator 50 and the inputs to gates 52 and 54, and arranged to toggle its output when the differentiator output crosses zero. The differentiator output crosses zero once for each positive and negative peak in the output of symbol delay line 40. This is the preferred instant to enable gates 52 and 54 and allow the outputs of window comparator 44 to set or reset the latch.

The operation of the bit slicer of FIG. 3a is illustrated in the timing diagram shown in FIG. 3b. Six symbol periods, each of duration D, are shown, The received demodulated waveform (In) is the upper trace, and the output 42 of symbol delay line 40 is the second trace. As can be seen, the output of the symbol delay line is equal to the difference between the value of demodulated waveform In and the value of In one symbol period D earlier. The next trace depicts the output of differentiator 50, which crosses zero at each peak in the symbol delay line output. Finally, the bottom trace shows the output of latch circuit 34: the latch changes state each time the differentiator output crosses zero, and the output of symbol delay line 42 is either greater than +Vₜₕ or less than −Vₜₕ. The output of latch circuit 34 is the bit-sliced data contained within received demodulated signal In.

The circuit shown in FIG. 3a acts to detect the peak of the differential slope in a received demodulated signal. As a result, the bit slicing performed by the present circuit is insensitive to variations in the DC offset which may be present in the received signal.

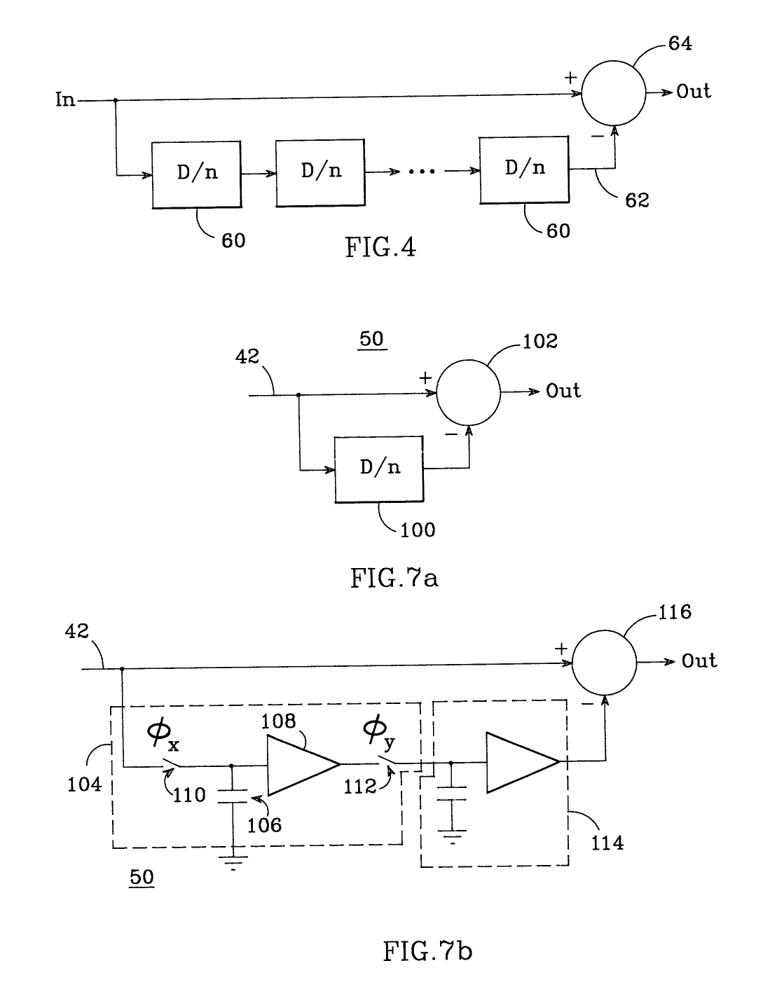

The receiver in a wireless data system often employs oversampling, in which each data bit is sampled n times. As noted above, slope level threshold detector 30 includes a symbol delay line 40 which implements a function of (1-D). One possible implementation of a symbol delay line which might be used when oversampling is employed is shown in FIG. 4. Here, the delay line is implemented with n delay cells 60 connected in series, each of which delays the incoming demodulated signal (In) by a period D/n. In this way, the output 62 of the last cell in the series is one symbol period behind the demodulated input signal. A subtractor 64 receives demodulated signal In at one input and the delayed signal 62 at a second input and outputs the difference—thereby implementing a function of (1-D). In this embodiment, each delay cell 60 is implemented using digital logic in a straightforward fashion.

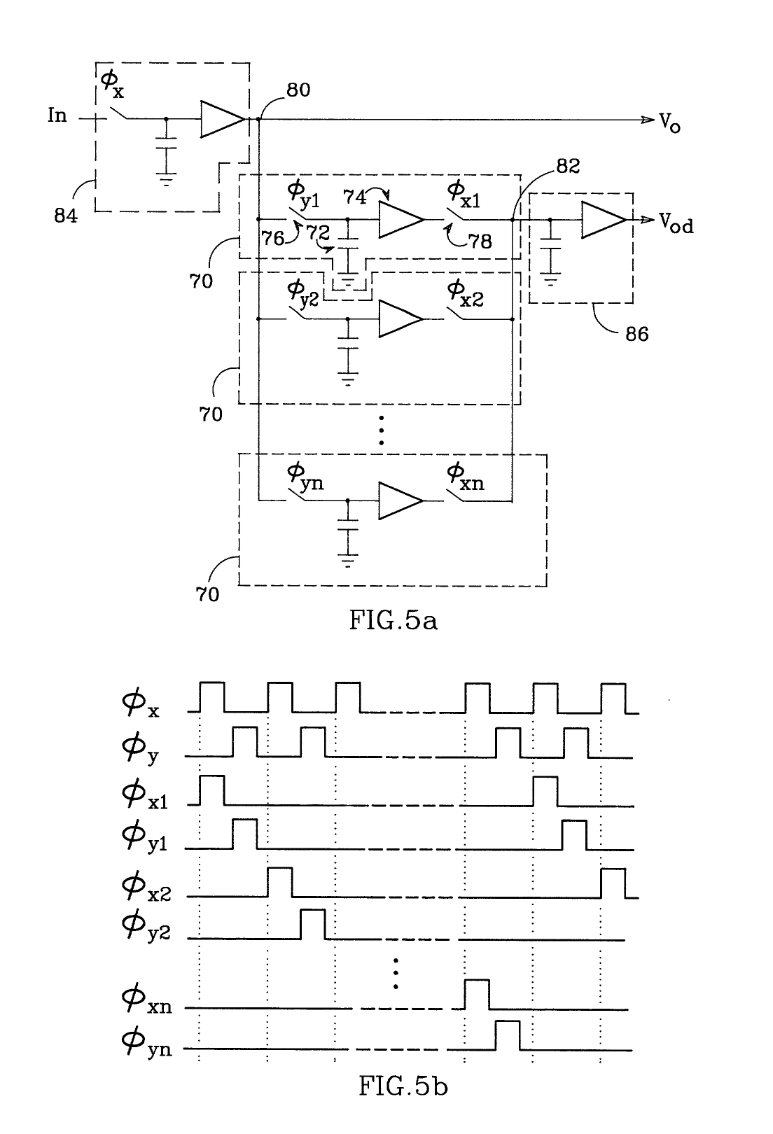

Symbol delay line 40 may also be implemented with analog circuitry; one possible implementation is shown in FIG. 5a. Here, the delay line comprises n delay cells 70 connected in parallel. Each cell 70 includes a capacitor 72, a buffer amplifier 74, an input switch 76 and an output switch 78. The input switches are connected together at a common node 80 which receives demodulated input signal In, and the output switches are connected together at a common node 82 at which the symbol delay line's output (V_{od}) is produced. To facilitate timing synchronization, there may be an additional delay cell 84 connected between the demodulated input signal and common node 80, and an additional delay cell 86 connected between common node 82 and output V_{od}.

The switches are operated with a multi-phase clock, arranged such that the cells are clocked at a rate of D/n, with each cell delaying the demodulated input signal by one symbol period. A timing diagram which illustrates the operation of the input and output switches is shown in FIG. 5b. The demodulated input is sampled sequentially on each of the capacitors such that each delay cell stores one of the n oversampled voltages. The stored voltages are sequentially output from their respective cells and provided to common node 82, with each cell outputting its stored voltage (via clock phases Φₓ₁-Φₓₙ) just before a new sample is stored on the cell (via clock phases (Φ_{y1}-Φ_{yn}). This arrangement requires that the clock have two non-overlapping phases Φₓ and Φ_{y}; Φₓ occurs before Φ_{y}, so that current output Vₒ and delayed output V_{od} are valid during the later Φ_{y} phase. Each of the Φₓᵢ and Φ_{yi} phases (i=1, 2, . . . , n) is active during one of the n slots as shown in FIG. 5b.

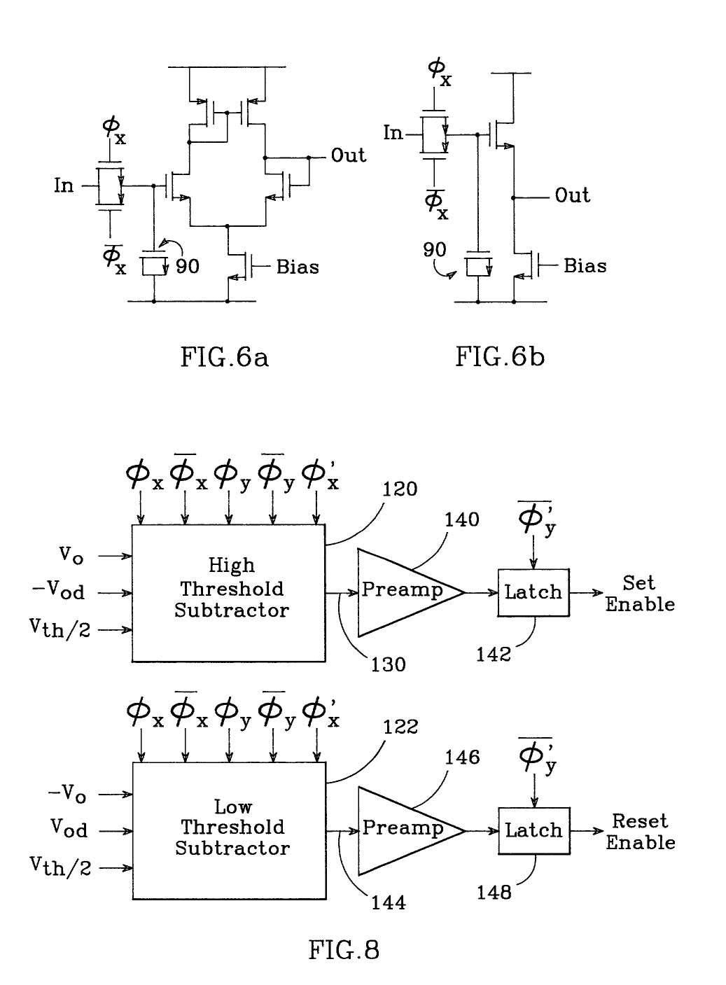

Possible implementations of analog delay cells 70 are shown in FIGS. 6a and 6b. In both FIGS. 6a and 6b, a MOS transistor 90 is employed as the delay cell's capacitor 72. In FIG. 6a, the buffer amplifier 74 is a voltage follower, while in FIG. 6b, the buffer amplifier is a source follower; though simpler, the source follower of FIG. 6b suffers from level shifting and attenuation. Note that the delay cells can be implemented in many different ways, depending on the accuracy required.

As noted above, slope polarity detector 32 is preferably a differentiator 50. Two possible differentiator implementations are shown in FIGS. 7a and 7b. FIG. 7a depicts a digital implementation of differentiator 50, which comprises a digital delay cell 100 and a subtractor 102. Differentiator 50 receives the output 42 of slope level threshold detector 40 at an input. Delay cell 100 imposes a delay of D/n on output 42, and subtractor 102 outputs the difference between output 42 and the output of delay cell 100.

One possible analog implementation of differentiator 50 is shown in FIG. 7b. Here, an analog delay cell 104 is configured as before, with a capacitor 106 receiving the output 42 of slope level threshold detector 40, a buffer amplifier 108 connected to the capacitor, and input and output switches (110, 112) at either end. Input switch 110 is operated with clock phase Φₓ and output switch 112 is operated with clock phase Φ_{y} in accordance with the timing diagram shown in FIG. 5b. This arrangement serves to impose a delay of D/n on output 42. An additional delay cell 114 may be connected to the output of delay cell 104 to facilitate timing synchronization. A subtractor 116 outputs the difference between output 42 and the output of delay cell 104.

When incoming data is oversampled as discussed above, slope level threshold detectors for detecting transitions that exceed high threshold Vₜₕ and low threshold −Vₜₕ can be simplified as shown in FIG. 8. A high threshold subtractor 120 receives voltages equal to Vₒ, −V_{od}, and Vₜₕ/2. Subtractor 120 also receives clock phases Φₓ, Φ_{y}, \overline{Φₓ}, \overline{Φ_{y}}, and a prime clock Φ′ₓ, where Φ′ₓ occurs just slightly before Φₓ. Similarly, a low threshold subtractor 122 receives voltages equal to −Vₒ, V_{od}, and Vₜₕ/2, and clock phases Φₓ, Φ_{y}, \overline{Φₓ}, \overline{Φ_{y}}, and Φ′ₓ.

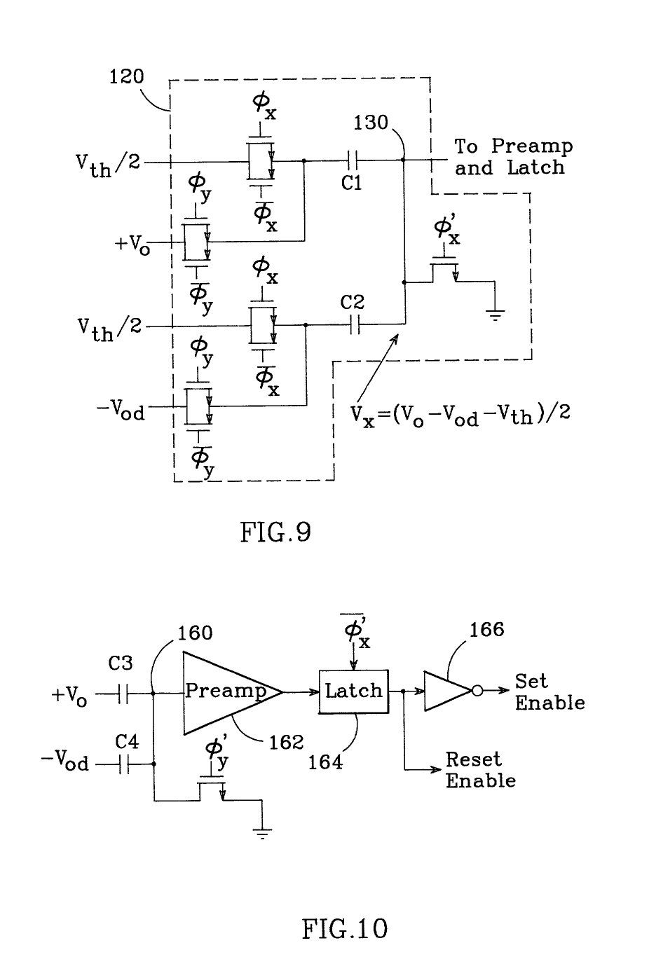

The high threshold subtractor 120 is preferably implemented as a capacitive subtractor as shown in FIG. 9. Two capacitors C1 and C2 are connected together at a common node 130. The other side of C1 is connected to voltage Vₜₕ/2 via a pair of switches operated with clock phases Φₓ and \overline{Φₓ}, and to voltage +Vₒ via a pair of switches operated with clock phases Φ_{y} and \overline{Φ_{y}}. The other side of C2 is connected to voltage Vₜₕ/2 via a pair of switches operated with clock phases Φₓ and \overline{Φₓ}, and to voltage −V_{od} via a pair of switches operated with clock phases Φ_{y} and \overline{Φ_{y}}. A switch operated with clock phase Φ′ₓ is connected between common node 130 and ground. Each switch is preferably implemented with a MOS transistor.

In operation, node 130 is initially charged to ground using prime clock Φ′ₓ. During the Φₓ phase, the bottom plates of capacitors C1 and C2 are connected to Vₜₕ/2. Then, during the later Φ_{y} phase, C1 is connected to +Vₒ and C2 is connected to −V_{od}. This arrangement causes the subtractor to take the difference between the input voltage change over one symbol period and the high threshold voltage. Thus, at the end of the Φ_{y} phase, the voltage Vₓ at common node 130 is given by:

Vₓ=(Vₒ−V_{od}−Vₜₕ)/2.

Referring back to FIG. 8, the voltage at common node 130 is preferably amplified with a preamp 140, the output of which is latched with a latch 142 clocked with a prime clock \overline{Φ′_{y}} (which occurs just before \overline{Φ_{y}}). The output of latch 142 is fed to AND gate 52 in latch circuit 34. When the polarity at common node 130 is positive, latch 142 is set high, thereby enabling the set input of latch circuit 34.

The low threshold subtractor 122 is preferably similarly implemented, such that it produces an output 144 which is given by (−Vₒ+V_{od}−Vₜₕ)/2. This output is amplified with a preamp 146 and latched with a latch 148 clocked with clock phase \overline{Φ′_{y}}. When the polarity of output 144 is positive, latch 148 is set high, thereby enabling the reset input of latch circuit 34.

Please note that the implementation of the high and low threshold subtractors are merely exemplary; the functions performed by the subtractors could be realized with many different circuit implementations.

The differentiator 50 may also be implemented with a capacitive subtractor; one possible implementation is shown in FIG. 10. Here, +Vₒ and −V_{od} are connected to capacitors C3 and C4, respectively, with the other ends of C3 and C4 connected together at a common node 160. A switch, preferably a MOS transistor, is connected between common node 160 and ground and is operated with prime clock Φ′_{y} (which occurs just before Φ_{y}). The voltage at node 160 is amplified with a preamp 162 and latched with a latch 164 clocked with a prime clock \overline{Φ′ₓ} (which occurs just before \overline{Φₓ}). The latched signal is provided to AND gate 54 of latch circuit 34 to enable its reset input; an inverter 166 inverts the latched signal and provides it to latch circuit 34 to enable its set input.

Please note that while the circuits shown in the figures are drawn as single-ended, the circuits can also be configured differentially.

While particular embodiments of the invention have been shown and described, numerous variations and alternate embodiments will occur to those skilled in the art. Accordingly, it is intended that the invention be limited only in terms of the appended claims.

I claim:

1. A DC-tolerant bit slicer suitable for detecting digital data contained within a demodulated signal received via a wireless data system having a predetermined symbol period D, comprising:
a slope level threshold detector which receives a demodulated signal via a wireless data system and detects whether said received signal transitions by more than a predetermined threshold value Vₜₕ during each of said symbol periods,
a slope polarity detector which detects the polarity of a transition detected by said slope level threshold detector, and
a latch which is set when said slope level threshold detector detects a transition and said slope polarity detector detects that the polarity of said transition is negative and is reset when said slope level threshold detector detects a transition and said slope polarity detector detects that the polarity of said transition is positive.

2. The bit slicer of claim 1, wherein said slope level threshold detector comprises:
a symbol delay line which implements a function of (1-D) such that the output of said symbol delay line varies with the difference between the value of said demodulated signal and the value of said demodulated signal one symbol period earlier, and
a window comparator having a first output which is toggled when the output of said symbol delay line is greater than +Vₜₕ and a second output which is toggled when the output of said symbol delay line is less than −Vₜₕ.

3. The bit slicer of claim 2, wherein said bit slicer operates at an oversampling rate n times the bit rate of the data bits contained within said demodulated signal, said symbol delay line comprising:
n delay cells implemented with digital logic and connected in series, the first cell of said series connected to receive said demodulated signal and each of said delay cells arranged to delay said demodulated signal by a time D/n, and
a subtractor which receives said demodulated signal at one input and the output of the last cell of said series at a second input, said subtractor arranged to subtract said second input from said first input and to output the result, said result being said function of (1-D).

4. The bit slicer of claim 2, wherein said bit slicer operates at an oversampling rate n times the bit rate of the received data bits, said symbol delay line comprising:
a delay circuit comprising:
n delay cells connected in parallel, each of said cells including a capacitor, said delay circuit arranged to sample said demodulated input sequentially on each of said capacitors such that each of said delay cells stores one of said n oversampled voltages, and to sequentially output the voltages held on said capacitors such that each of said delay cells delays its oversampled voltage for one symbol period D, and
a subtractor which receives said demodulated signal at one input and the voltages which are sequentially output from said n delay cells at a second input, said subtractor arranged to subtract said second input from said first input and to output the result, said result being said function of (1-D).

5. The bit slicer of claim 4, further comprising a final delay cell which includes a capacitor and is interposed between said voltages which are sequentially output from said n delay cells and said subtractor's second input, said final delay cell arranged to temporarily hold the voltages which are sequentially output from said n delay cells to facilitate timing synchronization.

6. The bit slicer of claim 1, wherein said slope polarity detector comprises a differentiator arranged to differentiate the output of said slope level threshold detector and thereby determine the polarity of a transition detected by said slope level threshold detector.

7. The bit slicer of claim 6, wherein said slope polarity detector comprises:
a delay cell implemented with digital logic, said delay cell connected to receive said demodulated signal and arranged to delay said demodulated signal by a time D/n, and
a subtractor which receives said demodulated signal at one input and the output of said delay cell at a second input, said subtractor arranged to subtract said second input from said first input to produce said slope polarity detector's output.

8. The bit slicer of claim 6, wherein said slope polarity detector comprises:
a first analog delay cell comprising:
an input switch connected to receive said demodulated signal,
a first capacitor which is connected to said demodulated signal when said input switch is closed,
a first buffer amplifier which is connected to said first capacitor at an input, and
an output switch connected to receive said buffer amplifier's output and which provides said delay cell's output, said input and output switches operated by the first and second phases, respectively, of a two-phase non-overlapping clock, and
a subtractor which receives said demodulated signal at one input and the output of said delay cell at a second input, said subtractor arranged to subtract said second input from said first input to produce the output of said slope polarity detector.

9. The bit slicer of claim 8, further comprising a second analog delay cell interposed between said first delay cell's output and said subtractor, said second analog delay cell comprising a second capacitor which is connected to said first delay cell's output and a second buffer amplifier which is connected to said second capacitor at an input and which produces an output to said subtractor, said second analog delay cell arranged to temporarily hold the voltage which is output from said first analog delay cell to facilitate timing synchronization.

10. The bit slicer of claim 8, wherein said analog delay cell is made exclusively from MOS transistors.

11. The bit slicer of claim 6, further comprising a comparator connected to the output of said differentiator, said comparator arranged to enable the set and reset inputs of said latch when said the output of said differentiator crosses zero.

12. The bit slicer of claim 1, wherein said latch comprises a set-reset (S-R) latch.

13. A DC-tolerant bit slicer suitable for detecting digital data contained within a demodulated signal received via a wireless data system having a predetermined symbol period D, comprising:
a slope level threshold detector which receives a demodulated signal via a wireless data system and detects whether said received signal transitions by more than a predetermined threshold value Vₜₕ during each of said symbol periods,
a differentiator arranged to differentiate the output of said slope level threshold detector to determine the polarity of a transition detected by said slope level threshold detector,
a comparator connected to the output of said differentiator, said comparator having an output which toggles from a first state to a second state when the output of said differentiator crosses zero, and
a first latch which is set when said slope level threshold detector detects a transition, said differentiator determines that the polarity of said transition is negative, and said comparator output toggles from a first state to a second state, and is reset when said slope level threshold detector detects a transition, said differentiator detects that the polarity of said transition is positive, and said comparator output toggles from a first state to a second state.

14. The bit slicer of claim 13, wherein said bit slicer operates at an oversampling rate n times the bit rate of the received data bits, said slope level threshold detector comprising a symbol delay line which implements a function of (1-D) such that the output of said symbol delay line varies with the difference between the value of said demodulated signal and the value of said demodulated signal one symbol period earlier, said symbol delay line comprising:
a delay circuit comprising:
n delay cells connected in parallel, each of said cells including a capacitor, said delay circuit arranged to sample said demodulated input sequentially on each of said capacitors such that each of said delay cells stores one of said n oversampled voltages, and to sequentially output the voltages held on said capacitors such that each of said delay cells delays its oversampled voltage for one symbol period D, and
a final delay cell which includes a capacitor and is connected to receive the voltages which are sequentially output from said n delay cells, said final delay cell arranged to temporarily hold the voltages which are sequentially output from said n delay cells to facilitate timing synchronization, and
a subtractor which receives said demodulated signal at one input and the output of said final delay cell at a second input, said subtractor arranged to subtract said second input from said first input and to output the result, said result being said function of (1-D).

15. The bit slicer of claim 13, wherein said bit slicer operates at an oversampling rate n times the bit rate of the received data bits, said slope level threshold detector comprising a symbol delay line which implements a function of (1-D) such that the output of said symbol delay line varies with the difference between the value of said demodulated signal and the value of said demodulated signal one symbol period earlier, said symbol delay line comprising:
a delay circuit having an input connected to receive said demodulated signal and an output, said delay circuit comprising:
n analog delay cells connected in parallel, each of which comprises:
an input switch connected to said delay circuit input,
a capacitor which is connected to said delay circuit input when said input switch is closed,
a buffer amplifier which is connected to said capacitor at an input and which produces an output, and
an output switch connected to the output of said buffer amplifier and which connects the output of said buffer amplifier to the output of said delay circuit when closed, said input and output switches operated with clocks having phases Φ_{yi} and Φₓᵢ (i=1, 2, . . . , n), respectively,
a multi-phase clock generator arranged to produce said clock phases Φ_{yi}, and Φₓᵢ (i=1, 2, . . . , n) such that said demodulated input is sampled sequentially on each of said capacitors such that each of said delay cells stores one of said n oversampled voltages, and such that the voltages held on said capacitors are sequentially output such that each of said delay cells delays its oversampled voltage for one symbol period D,
a “high” threshold subtractor connected to receive signals representing the output of said delay circuit (V_{od}), said demodulated signal (Vₒ), and said threshold voltage (Vₜₕ) and arranged to enable said first latch to be set if Vₒ−V_{od}>Vₜₕ, and
a “low” threshold subtractor connected to receive signals representing V_{od}, Vₒ, and Vₜₕ and arranged to enable said first latch to be reset if Vₒ−V_{od}<−Vₜₕ.

16. The bit slicer of claim 17, said delay circuit further comprising:
a first analog delay cell interposed between said demodulated signal and said delay circuit input, said first analog delay cell comprising a first switch connected to receive said demodulated signal, a first capacitor which is connected to said demodulated signal when said first switch is closed, and a first buffer amplifier which is connected to said first capacitor at an input and which produces an output to said delay circuit's input, said first switch operated with a clock which is in-phase with clock phase Φₓ₁, and
a final delay cell interposed between said delay cells' outputs and said delay circuit's output, said final delay cell comprising a capacitor connected to the outputs of each of said n analog delay cells and a buffer amplifier connected at its input to said capacitor and which produces said delay circuit's output at its output, said first analog delay cell and said final delay cell arranged to facilitate timing synchronization.

17. The bit slicer of claim 15, further comprising first and second preamplifiers connected to amplify the outputs of said “high” and “low” threshold subtractors, respectively, and second and third latches arranged to latch the amplified outputs of said “high” and “low” threshold subtractors, respectively, the output of said second latch enabling said first latch to be set and the output of said third latch enabling said first latch to be reset.

18. The bit slicer of claim 15, wherein said “high” threshold subtractor is a capacitive subtractor comprising:
input terminals connected to receive voltages equal to Vₜₕ/2, +Vₒ, and −V_{od} and clocks having phases Φₓ, Φ_{y}, \overline{Φₓ}, \overline{Φ_{y}}, and Φ′ₓ,
first and second capacitors,
first and second switches which connect Vₜₕ/2 to the first terminal of said first capacitor in response to clock phases Φₓ and \overline{Φₓ}, respectively,
third and fourth switches which connect +Vₒ to the first terminal of said first capacitor in response to clock phases Φ_{y} and \overline{Φ_{y}},
fifth and sixth switches which connect Vₜₕ/2 to the first terminal of said second capacitor in response to clock phases Φₓ and \overline{Φₓ}, respectively,
seventh and eighth switches which connect −V_{od} to the first terminal of said second capacitor in response to clock phases Φ_{y} and \overline{Φ_{y}}, the second terminals of said first and second capacitors connected together at a first node, said first node being the output of said high threshold subtractor, and
a ninth switch which connects said first node to ground in response to clock phase Φ′ₓ,
said multi-phase clock generator further arranged to produce said clock phases such that:
said first node is initially charged to ground in response to clock phase Φ′ₓ,
the first terminals of said first and second capacitors are connected to Vₜₕ/2 in response to clock phases Φₓ and \overline{Φₓ}, and
the first terminals of said first and second capacitors are connected to +Vₒ and −V_{od}, respectively, in response to clock phases Φ_{y} and \overline{Φ_{y}},
such that the voltage at said first node at the end of clock phases Φ_{y} and \overline{Φ_{y}} is given by (Vₒ−V_{od}−Vₜₕ) Vₜₕ/2.

19. The bit slicer of claim 18, wherein each of said switches is a MOS transistor.

20. The bit slicer of claim 13, wherein said differentiator comprises:
input terminals connected to receive voltages +Vₒ and −V_{od} and clocks having phases \overline{Φ′ₓ} and Φ′_{y},
first and second capacitors, the first terminals of said first and second capacitors connected to +Vₒ and −V_{od}, respectively, and the second terminals of said first and second capacitors connected together at a first node,
a switch which connects said first node to ground in response to clock phase Φ′_{y},
a preamplifier which amplifiers the signal at said first node,
a second latch which latches the output of said preamplifier in response to clock phase \overline{Φ′ₓ},
said multi-phase clock generator further arranged to produce said clock phases such that phase \overline{Φ′ₓ} occurs after Φ′_{y}, such that said second latch stores the difference between two consecutive samples.

21. A method for detecting digital data contained within a demodulated signal received via a wireless data system having a predetermined symbol period D, comprising:
detecting, during each of said symbol periods, when a received demodulated signal transitions by more than a predetermined threshold value Vₜₕ,
detecting the polarity of each detected transition, and
outputting a logic “1”, when a detected transition has a negative polarity and outputting a logic “0” when a detected transition has a positive polarity.

22. The method of claim 21, wherein detecting when a received demodulated signal transitions by more than a predetermined threshold value Vₜₕ during each of said symbol periods comprises:
producing an output which is a function of (1-D) such that the output varies with the difference between the value of said demodulated signal and the value of said demodulated signal one symbol period earlier, and
comparing the output of said function with a positive threshold voltage +Vₜₕ and a negative threshold voltage −Vₜₕ, and
toggling an output when said function of (1-D) exceeds +Vₜₕ or −Vₜₕ.

23. The method of claim 21, wherein detecting the polarity of each detected transition comprises differentiating the output of said function of (1-D).
